(19) United States
(12) Patent Application Publication
(10) Pub. No.: US 2016/0350094 A1
(43) Pub. Date: Dec. 1, 2016

(54) APPLICATION DOWNLOAD EMULATION

(71) Applicant: Google Inc., Mountain View, CA (US)

(72) Inventors: Dong Ha Lee, Palo Alto, CA (US); Jaehyun Yeom, Mountain View, CA (US); Jongho Choy, San Jose, CA (US)

(21) Appl. No.: 14/721,516

(22) Filed: May 26, 2015

(51) Int. Cl. G06F 9/445; G06F 9/455

(52) U.S. Cl. CPC G06F 8/61; G06F 9/45508

(57) ABSTRACT

Methods, systems, and apparatus, including computer programs encoded on a computer storage medium, for providing a cloud emulation of a native application accessible at a user device while the native application is downloading on the user device. After the downloading is complete, the user device may retrieved the state data generated during the cloud emulation and launch the native application and resume the state of the native application as achieved by the cloud emulator.

### BACKGROUND

The Internet provides access to a wide variety of information. For example, digital image files, video and/or audio files, as well as web page resources for particular subjects or particular news articles, are accessible over the Internet. With the advent of tablet computers and smart phones, native applications have become extremely popular. It is not uncommon for a single user device to have dozens of native applications installed.

As mobile devices become more powerful, however, so have the capabilities of native applications. This often results in an increase in the executable size of the native application and an increase in the size of supporting resources, e.g., graphics that are downloaded. Thus, it may take several minutes, or longer, to download a native application. During this time, the user must wait until the download is complete before the native application can be launched.

### SUMMARY

This specification describes technologies relating to automatically launching a native application emulation during the download of a native application.

In general, one innovative aspect of the subject matter described in this specification can be embodied in methods that include the actions of receiving from a user device that is separate from the data processing apparatus, a notification for a native application installation for the user device, and in response: instantiating, other than at the user device, an emulation instance of the native application to generate an instantiation of the native application, establishing, with the user device, a communication of the emulation instance to an emulation environment on the user device, wherein the emulation environment on the user device is separate from the instantiation of the native application on the user device, processing data received from the emulation environment on the user device in the emulation instance for the native application, and storing state data describing a state of the emulation instance of the native application; and in response to a completion of the native application installation on the user device, providing the state data to the user device, wherein the state data is used at the user device to instantiate the native application on the user device at the described state. Other embodiments of this aspect include corresponding systems, apparatus, and computer programs, configured to perform the actions of the methods, encoded on computer storage devices.

In general, another innovative aspect of the subject matter described in this specification can be embodied in methods that include the actions of receiving, at the user device and from an emulation server, in response to the initiation of a native application installation at the user device, a communication of an emulation instance of the native application to an emulation environment on the user device, wherein the emulation environment is separate from the instantiation of the native application on the user device; receiving data input in the emulation environment at the user device, providing the data to the emulation server, and receiving updates to the emulation environment responsive to the provided data until a completion of native application installation at the user device; receiving, from the emulation server, state data describing a state of the emulation instance of the native application; in response to a completion of the installation of the native application at the user device: instantiating the native application at the user device; and accessing the state data to instantiate the native application at the state of the emulation instance. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. Emulation of a native application during an application installation allows the user to enjoy the experience of an application immediately during the installation process. This results in a higher user engagement with the application. Transferring the state of the emulated instance of the native application to the user device upon installation completion allows the user device to switch to the native application from the emulation environment in a relatively seamless manner. The continuation of the native application state also makes it more likely that users will engage with the emulated native application, as users' work done during the emulation is not lost when the native application installation is completed and the native application launches.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a native application emulation occurs on a user device while the native application is installing on the user device.

FIG. 2 is a flow diagram of an example process emulating a native application during an installation of the native application.

FIGS. 3A-3E are illustrations of a user device user interface during an application installation and emulation.

Like reference numbers and designations in the various drawings indicate like elements.

### DETAILED DESCRIPTION

A cloud-based system emulates a native application for a user device and provides the emulation to an emulation environment on the user device while the native application is being installed on the user device. At the completion of the installation, the state of the native application emulated in the cloud-based system is provided to the user device. The user device uses the state data to instantiate the native application to the same state that the user experienced in the emulation environment. Thus, from the workflow perspective, the transfer to the actual native application from the emulation environment is seamless.

As used herein, “installing a native application on a user device” means downloading and installing the native application on the user device, or installing the native application from a local storage device. A native application is an application that runs on a user device and that operates independent of a browser application on the user device. In particular, a native application is an application specifically designed to run on a particular user device operating system and machine firmware. Native applications thus differ from browser-based applications and browser-rendered resources. The latter require all, or at least some, elements or instructions downloaded from a web server each time they are instantiated or rendered. Furthermore, browser-based applications and browser-rendered resources can be processed by all web-capable mobile devices within the browser and thus are not operating system specific.

These features and other features are described in more detail below.

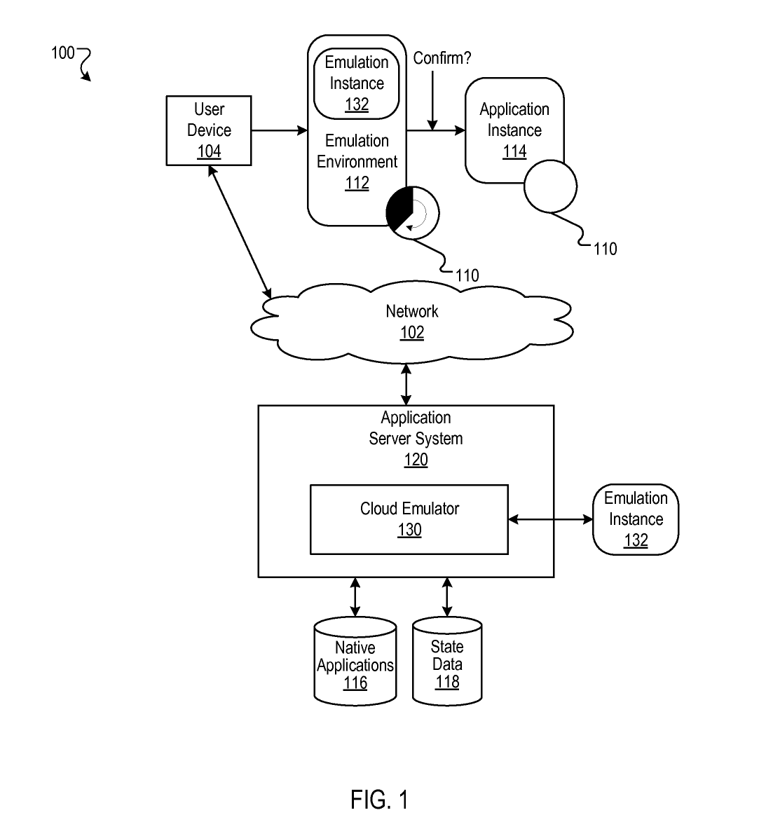

FIG. 1 is a block diagram of an example environment 100 in which a native application emulation occurs on a user device while the native application is installing on the user device. A computer network 102, such as the Internet, connects a user device 104 and an application server system 120. The application server system 120 may be a retailer of native applications that provide native applications 116 to user devices, or, alternatively, may be a publisher of a particular native application 116. Thus, the features described below can be used by both sellers of multiple native applications 116 from multiple publishers, or by a particular publisher.

As described above, a native application 116 is an application specifically designed to run on a particular user device operating system and machine firmware. Native applications 116 may include multiple versions designed to run on different platforms. For example, native applications corresponding to a movie database website may include a first native application that runs on a first type of smart phone, a second native application that runs on a second type of smart phone, a third native application that runs on a first type of tablet, etc.

A user device 104 is an electronic device that is under the control of a user. A user device 104 is typically capable of requesting and receiving native applications 116 over the network 102. Example user devices 104 include personal computers, mobile communication devices, and tablet computers.

As shown in FIG. 1, the application server system 120 includes a cloud emulator 130. While shown as part of the server system 120, the cloud emulator 130 can also be realized as a stand-alone system administered by a third party. However, for brevity only and not to exclude other implementations, the cloud emulator 130 is described in the context of being a subsystem of the application server system 130.

When a native application is being installed on the user device 104, the cloud emulator generates an emulation instance 132 of the native application 116. As used in this specification, an “emulation instance” of a native application is an instantiation of the native application by the cloud emulator 130 that is provided to the user device 104 in the form of a cloud-based application. Most of the resources to support the emulation instance, e.g., memory, processing, etc., are provided by the cloud emulator 130.

The emulation instance 132 is provided to an emulation environment 112 on the user device. An emulation environment 112 is an environment in which the content of emulation instance 132 is rendered and through which the user may interact with the emulation instance 132 in a manner that supports the functionality of the native application 116 as though it were executing on the user device 104 itself.

One example emulation environment is a web browser. In this implementation, the native application 116, executing on the cloud emulator 130, is provided as a web service to the user device 104 through the browser. The actual emulation is thus in the cloud emulator 130 and the web browser communicates over the network 102 with the cloud emulator 130. For example, the web browser generates a user interface through which the emulation instance can be accessed by the user.

Other emulation environments can also be used. For example, the application server system 120 can provide a separate application to the user device 104 that supports an emulation environment 112 for native applications 116. The application need not be a web browser, but can instead be a stateful application. A variety of applications to support an emulation environment can be used, so long as the functionality of the native application 116 operating in the cloud emulator 130 is provided to and realized on the user device 104.

The emulation instances 132 of the native application 116 continues in the emulation environment 112 while the installation progresses, as indicated by the installation progress icon 110. During this time, state data 118, which is state data describing a state of the emulation instance 132 of the native application 116, is stored at the cloud emulator 130. Upon completion of the installation of the native application at the user device 104, as indicated by completed progress icon 110, the state data is provided to the user device 104. The state data 104 is used by the native application 116 now installed at the user device to instantiate to the same state that the emulation instance 132 was at when the installation on the user device 104 was completed. A user may notice a change in some user interface features, e.g., changing from a browser environment to the native application environment, but the user's work, inputs, and current location in the native application are not lost during the transition. Thus, from a users' workflow experience, the transition to an actual instantiation of the native application 116 on the user device 104 is seamless.

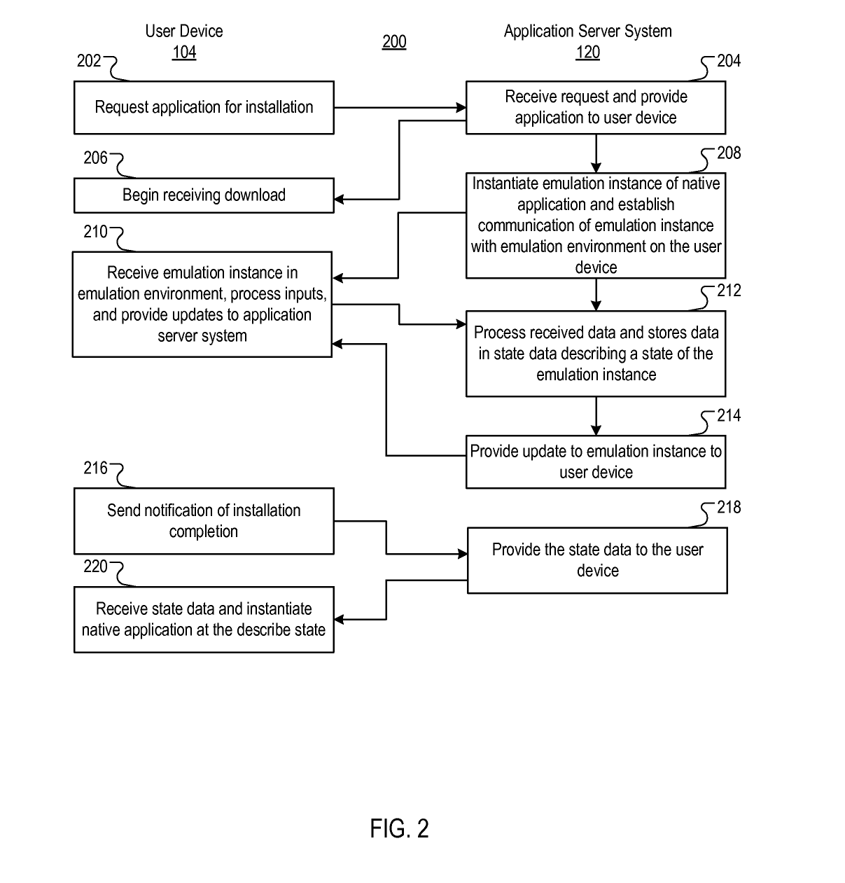

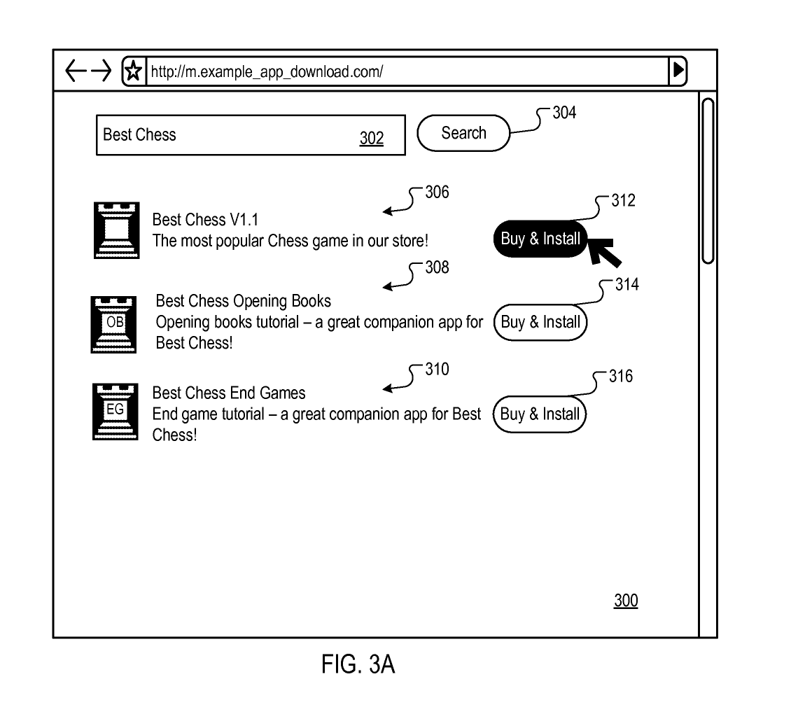

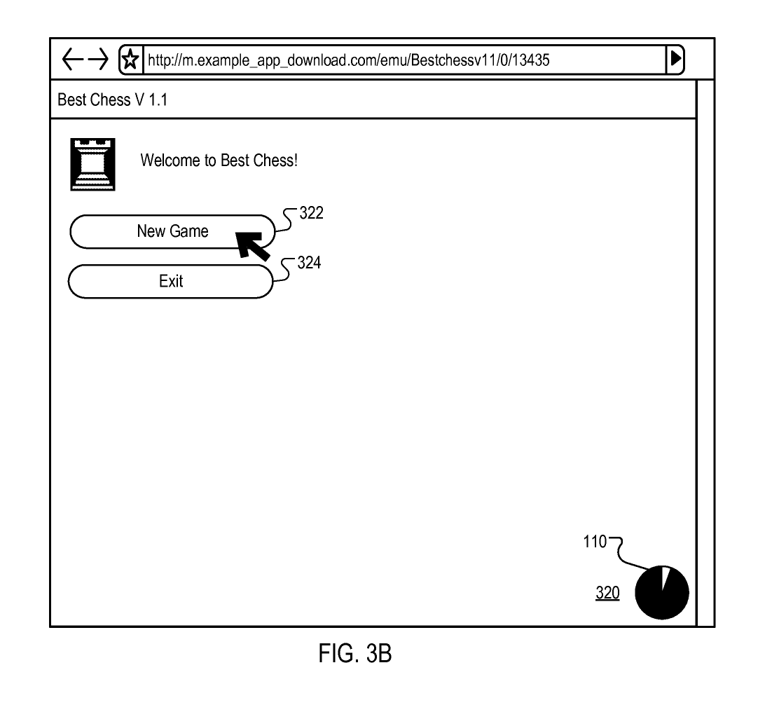

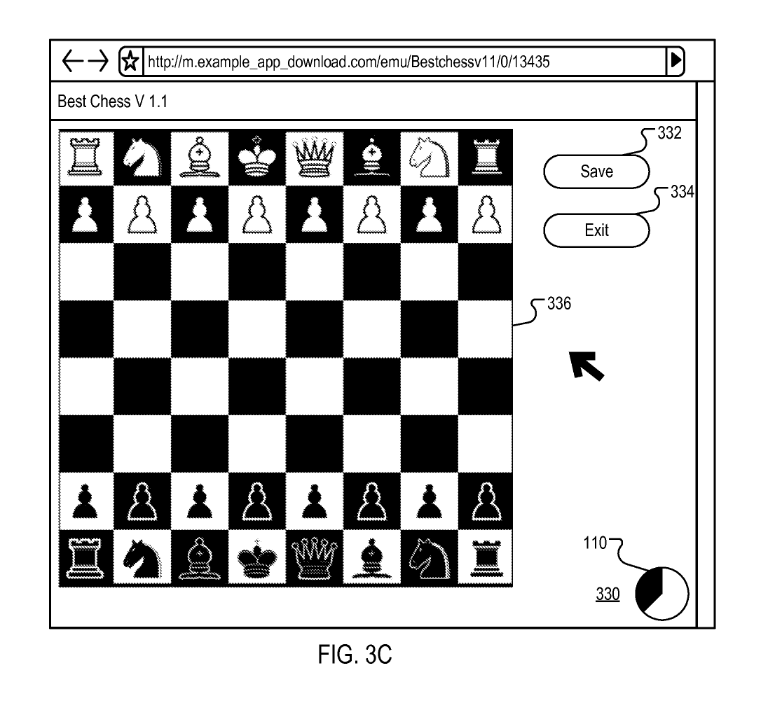

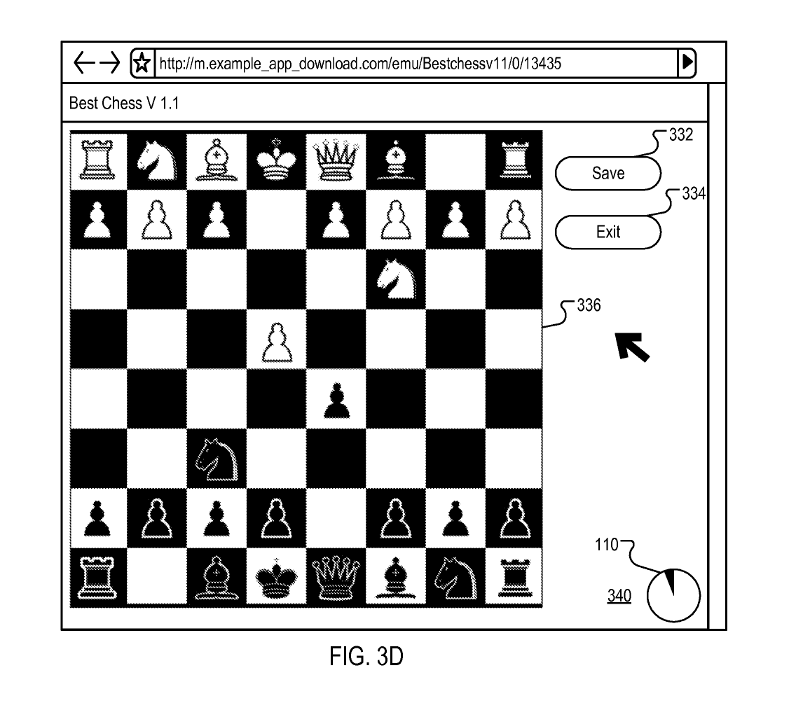

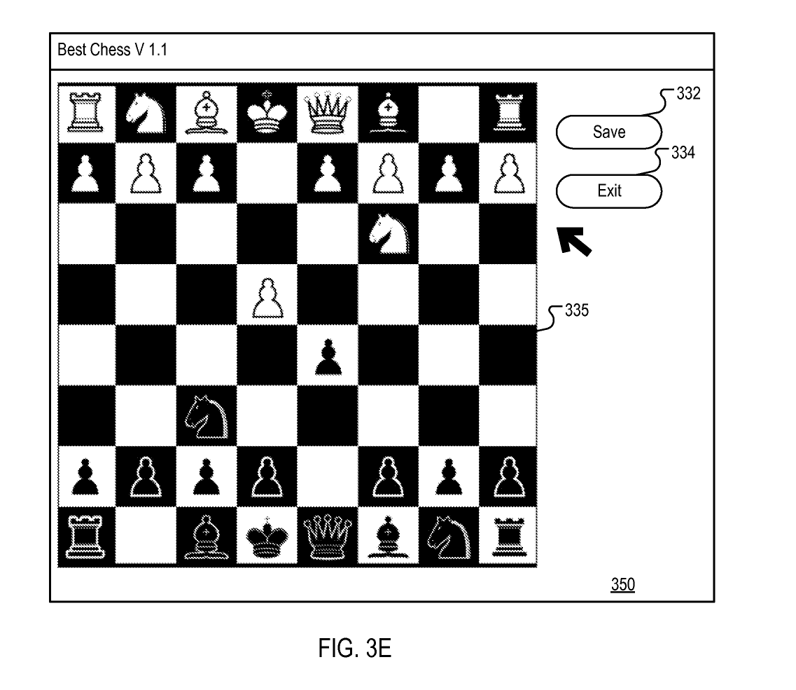

FIG. 2 is a flow diagram of an example process 200 emulating a native application during an installation of the native application. The left most portion of the process occurs in a user device 104, and the right most portion of the process occurs within a server system separate from the user device 104. Operation of the process 200 is described with reference to FIGS. 3A-3E, which are illustrations of a user device user interface during an application installation and emulation.

The user device 104 requests an application for installation (202). For example, FIG. 3A depicts a web-based interface 300 for the application server system 120. A user has queried [Best Chess] in an input field 302 and selected the search button 304. The application search results 306, 308 and 310 are shown, along with respective purchase and installation buttons 312, 314, and 316. In FIG. 3A, the user has purchased the application “Best Chess V1.1,” as indicated by the selection of the button 312. This causes the user device to send a command to the server system 120 to purchase and provide the native application for download and installation.

The server system 120 receives the request and provides the application to the user device (204). For example, the server system 120 establishes a connection with the user device 104 so that the user device may download the native application, and the user device begins receiving the download (206).

In an alternate implementation, the software may be provided by a tangible program carrier, such as a flash drive or DVD. The installation software may include a notification instruction that provides a notification to cloud emulator 130 that the user is installing the software. Upon beginning an installation, the user device 104 notifies the cloud emulator 130 of the installation. Thus, an emulation instance and environment, describe below, can be provided when the native application is being installed by means other than downloading from a web server.

The server system 120, by way of the cloud emulator 130, instantiates an emulation instance 132 of the native application and establishes a communication of the emulation instance with an emulation environment 112 on the user device (208). The user device 104, in turn, receives the emulation instance in the emulation environment, processes the inputs, and provides updates to application server system (210). For example, the cloud emulator 130 may launch the native application and provide a web-based UI that is substantially the same as the UI features of the native application running on the user device to the user device 104. An illustration of an example native application emulation shown in an emulation environment is illustrated in FIG. 3B. The user interface 320 is an active browser window in which is shown primary menu items 322 and 324 for the native application. The native application is actually running on the cloud emulator 130, and inputs provided at the user device 104 are, in turn, transmitted to the emulation instance 132 running on the cloud emulator 130. In some implementations, a progress icon 110 is shown to indicate the emulation environment and to show the progress of the native application installation.

The server system processes received data and stores data in state data describing a state of the emulation instance (212), and the server system provides an update of emulation instance to user device (214). For example, as shown in FIG. 3C, the user has started a chess game in the emulation environment, and by FIG. 3D, several moves have been made. At this time the installation is nearly complete, as indicated by the progress icon 110. The state of the chess game, e.g., the moves made, computer playing level, etc., are stored in the state data 118.

The user device sends a notification of installation completion (216). For example, after determining the native application has been successfully downloaded, the user device 104 notifies the server system 120 of the completed installation. In turn, the server system 120 provides the state data to the user device (218). For example, state of the chess game, e.g., the moves made, computer playing level, etc., are provided to the user device 104.

In some implementations, if native application supports cloud based saving of data, the native application may simply access the cloud storage and resume at the state specified by the state data.

In some implementations, the state data is provided to the user device 104 in the form of a token attached to a uniform resource indicator (URI) for the native application. The URI and token constitute a deep link that, when processed by the native application, cause the native application to instantiate at the state defined by the state data. Other ways of providing state data, such as by encoded strings, CGI parameters, and data files provided from the server 120, can also be used.

For native applications that facilitate local storage on a user device, in some implementations, the emulation environment 112 may include instructions that cause the state data to be written to local storage on the user device 104. Thus, the state data 118 can be updated and stored at the user device 104 instead of, or in addition to, storage at the server 120. This may reduce latency when transitioning from the emulation environment 112 to the actual instantiation of the native application at the user device 104.

Other appropriate ways of processing state data can also be used. For example, the cloud emulator 130 may provide an instruction to the native application on the user device that includes a command line parameter with a URI at which the state data may be retrieved. Upon launching, the native application requests the state data from the URI provided by the cloud emulator 130. Alternatively, the native application may be configured to automatically check for state data upon launching.

The user device 104 receives the state data and instantiates the native application at the describe state (220). For example, as shown in FIG. 3E, which is an illustration of the user interface 350 of the native application running at the user device 104, the native application has launched into the state at which the emulation instance 132 was at just prior to the user device 104 switching to the native application.

In some implementations, the user may be prompted to confirm an emulation of the native application. Should the user deny the emulation, then the native application installs without the emulation environment. In other implementations, the user device 104, in response to detecting the completion of the native application installation, displays a request for the user to confirm instantiation of the native application at the user device, and the cloud emulator 130 provides the state data to the user device only in response to receiving a confirmation of the request. Should the user deny the request, the emulation may continue, or, alternatively, may cease automatically to free up resources for the cloud emulator.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by data processing apparatus comprising one or more computers in data communication, the method comprising:
receiving, at a data processing apparatus that is separate from a user device, a notification for a native application installation for the user device, and in response:
instantiating, other than at the user device, an emulation instance of the native application to generate an instantiation of the native application;
establishing, with the user device, a communication of the emulation instance to an emulation environment on the user device, wherein the emulation environment on the user device is separate from the instantiation of the native application on the user device;
processing data received from the emulation environment on the user device in the emulation instance for the native application and generating updates to the emulation environment in response;
providing the updates to the emulation environment to the user device; and
providing, to the user device, state data describing a state of the emulation instance of the native application and, in response to the processing of data received from the emulation environment on the user device, updates to state data responsive to the processing of data received from the emulation environment for storage at a local storage on the user device;
wherein the state data and the updates to the state data are used at the user device to instantiate the native application on the user device at the described state.

2. The computer-implemented method of claim 1, wherein establishing, with the user device, a communication of the emulation instance to an emulation environment on the user device comprises serving the emulation instance of the native application to a browser user interface through which the emulation instance can be accessed by the user.

3. The computer-implemented method of claim 1, wherein providing the state data to the user device comprises providing a URI for the native application to the user device, wherein the URI includes a token that includes the state data.

4. (canceled)

5. (canceled)

6. A computer-implemented method performed by a user device, the method comprising:
receiving, at the user device and from an emulation server, in response to the initiation of a native application installation at the user device, a communication of an emulation instance of the native application to an emulation environment on the user device, wherein the emulation environment is separate from the instantiation of the native application on the user device;
receiving data input in the emulation environment at the user device, providing the data to the emulation server, and receiving updates to the emulation environment responsive to the provided data until a completion of native application installation at the user device;
receiving, from the emulation server, state data describing a state of the emulation instance of the native application, the receiving comprising receiving updates to the state data that correspond to the updates to the emulation environment and causing, by the emulation instance at the user device, storing of the updates to the state data on a local storage on the user device;
in response to a completion of the installation of the native application at the user device:
instantiating the native application at the user device; and
accessing the state data and the updates to the state data stored at the user device to instantiate the native application at the state of the emulation instance.

7. The computer-implemented method of claim 6, wherein the emulation environment comprises a browser user interface through which the emulation instance can be accessed by the user.

8. (canceled)

9. (canceled)

10. (canceled)

11. A system, comprising:
a data processing apparatus; and
software stored in non-transitory computer readable storage medium storing instructions executable by the data processing apparatus and that upon such execution cause the data processing apparatus to perform operations comprising:
receiving from a user device that is separate from the data processing apparatus, a notification for a native application installation for the user device, and in response:
instantiating, other than at the user device, an emulation instance of the native application to generate an instantiation of the native application;
establishing, with the user device, a communication of the emulation instance to an emulation environment on the user device, wherein the emulation environment on the user device is separate from the instantiation of the native application on the user device;
processing data received from the emulation environment on the user device in the emulation instance for the native application and generating updates to the emulation environment in response;
providing the updates to the emulation environment to the user device; and
providing, to the user device, state data describing a state of the emulation instance of the native application and, in response to the processing of data received from the emulation environment on the user device, updates to state data responsive to the processing of data received from the emulation environment for storage at a local storage on the user device;
wherein the state data and the updates to the state data are used at the user device to instantiate the native application on the user device at the described state.

12. The system of claim 11, wherein establishing, with the user device, a communication of the emulation instance to an emulation environment on the user device comprises serving the emulation instance of the native application to a browser user interface through which the emulation instance can be accessed by the user.

13. The system of claim 11, wherein providing the state data to the user device comprises providing a URI for the native application to the user device, wherein the URI includes a token that includes the state data.

14. (canceled)

15. A user device, comprising:
a data processing apparatus; and
software stored in non-transitory computer readable storage medium storing instructions executable by the data processing apparatus and that upon such execution cause the data processing apparatus to perform operations comprising:
receiving, at the user device and from an emulation server, in response to the initiation of a native application installation at the user device, a communication of an emulation instance of the native application to an emulation environment on the user device, wherein the emulation environment is separate from the instantiation of the native application on the user device;
receiving data input in the emulation environment at the user device, providing the data to the emulation server, and receiving updates to the emulation environment responsive to the provided data until a completion of native application installation at the user device;
receiving, from the emulation server, state data describing a state of the emulation instance of the native application, the receiving comprising receiving updates to the state data that correspond to the updates to the emulation environment and causing, by the emulation instance at the user device, storing of the updates to the state data on a local storage on the user device;
in response to a completion of the installation of the native application at the user device:
instantiating the native application at the user device; and
accessing the state data and the updates to the state data stored at the user device to instantiate the native application at the state of the emulation instance.

16. The user device of claim 15, wherein the emulation environment comprises a browser user interface through which the emulation instance can be accessed by the user.

17. (canceled)

18. The user device of claim 15. wherein receiving, from the emulation server, the state data comprises:
sending, from an instance of the native application instantiated at the user device to the emulation server, a request for the state data; and
receiving the state data in response to the request.

19. A non-transitory computer readable storage medium storing instructions executable by a data processing apparatus and that upon such execution cause the data processing apparatus to perform operations comprising:
receiving from a user device that is separate from the data processing apparatus, a notification for a native application installation for the user device, and in response:
instantiating, other than at the user device, an emulation instance of the native application to generate an instantiation of the native application;
establishing, with the user device, a communication of the emulation instance to an emulation environment on the user device, wherein the emulation environment on the user device is separate from the instantiation of the native application on the user device;
processing data received from the emulation environment on the user device in the emulation instance for the native application and generating updates to the emulation environment in response;
providing the updates to the emulation environment to the user device; and
providing, to the user device, state data describing a state of the emulation instance of the native application and, in response to the processing of data received from the emulation environment on the user device, updates to state data responsive to the processing of data received from the emulation environment for storage at a local storage on the user device;
wherein the state data and the updates to the state data are used at the user device to instantiate the native application on the user device at the described state.

20. A non-transitory computer readable storage medium storing instructions executable by a data processing apparatus and that upon such execution cause the data processing apparatus to perform operations comprising:
receiving, at the user device and from an emulation server, in response to the initiation of a native application installation at the user device, a communication of an emulation instance of the native application to an emulation environment on the user device, wherein the emulation environment is separate from the instantiation of the native application on the user device;
receiving data input in the emulation environment at the user device, providing the data to the emulation server, and receiving updates to the emulation environment responsive to the provided data until a completion of native application installation at the user device;
receiving, from the emulation server, state data describing a state of the emulation instance of the native application, the receiving comprising receiving updates to the state data that correspond to the updates to the emulation environment and causing, by the emulation instance at the user device, storing of the updates to the state data on a local storage on the user device;
in response to a completion of the installation of the native application at the user device:
instantiating the native application at the user device; and
accessing the state data and the updates to the state data stored at the user device to instantiate the native application at the state of the emulation instance.

21. The computer implemented method of claim 1, further comprising providing progress data that causes the emulation environment at the user device to display an installation progress indicator describing an installation progress status of the native application.

22. The computer implemented method of claim 6, further comprising displaying, in the emulation environment, an installation progress indicator describing an installation progress status of the native application.
